(19) United States
(12) Patent Application Publication
(10) Pub. No.: US 2005/0177382 A1
(43) Pub. Date: Aug. 11, 2005

(54) System and method of supporting the design management development of a packaging prototype and the production and manufacturing of packaging based on the packaging prototype

(76) Inventors: Gordon Plotkin, Nyack, NY (US); Kevin Williams, Ghent, NY (US)

Correspondence Address: THE MARTINEZ GROUP PLLC;Mark Sgantzos, 55 Poplar Street, Suite 1-D, Brooklyn, NY, 11201-6930, US

(21) Appl. No.: 10/773,679

(22) Filed: Feb. 6, 2004

(51) Int. Cl. G06F 17/60

(52) U.S. Cl. 705/1

(57) ABSTRACT

A system and method of supporting the design management development of a packaging prototype and the production and manufacturing of packaging based on the packaging prototype where a communication platform is created between a design manager, a separator, a designer and a printer. The communication platform involves having a Protocol, a P3 or Production Planned Prototype and a Plan. The Protocol involves understanding objectives, providing baseline expertise, exploring opportunities and identifying obstacles or problems. The Production Planned Prototype or P3 emulates the specific print process chosen for final production and the Plan provides a print sample, black and white progressive proofs, production specifications, key learnings, color swatches and digital support files.

### FIELD OF THE INVENTION

The present invention relates to the field of packaging development through a continual presence to create a package prototype which forms the production standard or target for the final packaging, and more particularly, to a business method, which creates a communication platform between suppliers (a designer, a color separator and a printer) and a design manager in order to efficiently develop such a prototype and facilitate the production of the final commercial package.

### BACKGROUND OF THE INVENTION

Traditional packaging development is a component of the commercialization process, which includes product development, manufacturing engineering, package engineering, package design, media campaigns and trade promotion as shown in prior art FIG. 1A. In order to effectively develop a product for market, a prototype is first created, said prototype serving as the basis for the final packaging. All the above stages of the commercialization process must be optimized, since delays would set back the launch date of the product, which would result in lost earnings, business opportunities or ineffective delivery dates, each or any of which could result in tremendous monetary losses. Specifically, and with regards to packaging design, the phased design process includes a series of steps which begin with an objectives brief directed to the design and nature of the package to be created, including a pre-design survey, a review of agencies qualified to undertake the design, a solicitation of estimates to understand the costs associated with designing and producing the package and a review of the estimates. These steps result in a final execution process that comprises a final review by the creative team, preliminary print production, the creation of printing mechanicals, creating color separations from the mechanicals and photographic elements, plate making, packaging production, and the shipping and packaging of the product as shown in prior art FIG. 1B(1)(2). The above phased design processes requires three basic areas of expertise, each of which are controlled by a design manager; a designer which designs the prototype, a separator which provides the color layers needed to achieve the desired look of the prototype, and a printer which prints the design based on available printing methods. The separator, the designer and the printer, all report to the design manager to manage the phases of the packaging design as shown in prior art FIG. 1C, where the design manager communicates individually with the designer, separator and the printer. The complexity of current design, print production and final package production process produces conflicts between the timing of the phased design process and the need to produce the final product by its predetermined launch date because the parties responsible for translating the design into the final package rely upon a design target or comprehensive that does not accurately reflect the desired and approved final design. Under such circumstances the deadlines identified in a launch date are postponed due to the need to remake the components necessary to create the final packaging so as to ensure final package production that matches the design target. Currently, one unified system and method of following packaging prototype development from initiation to final production printing that is convenient or possible with traditional methods does not exist.

It is an object of the present invention to provide a direct line of communication between all aspects of the design process.

It is a further object of the invention to provide a communication platform between all suppliers involved to create a package design in a timely manner.

It is further an object of the present invention to provide a system of bringing a packaging design and marketing program to completion on its intended launch date.

It is a further object of the present invention to reduce the risks and costs with missed deadlines due to the differences between a design target and a final package by correlating all phases of designing the prototype and creating the components necessary to produce the final package so that practical deadline dates can be established during the design process in order to meet a predetermined launch date of the production and marketing of the subject product.

### SUMMARY OF THE INVENTION

The features and advantages of the present invention are achieved by providing a system and method, which is capable of unifying all aspects of the design process used in creating a packaging prototype, facilitating the pre-printing production of the final package prototype and coordinating the printing and production of the final package, which is not currently possible with traditional business methods.

The system and method of the instant invention addresses the above-identified problems by providing a system where the separator, the designer and the printer, are in direct communication with the design manager as well as with each other. This system addresses potential problems, which may arise during the design process by providing a basis for communication, or communication platform between the separator, a designer and the printer distinct from the design manager. The system and method of the instant invention is realized in three distinct parts, the distinct parts including Protocol, P3 or Production Planned Prototype and Plan. Protocol involves the application of the collective experience and knowledge, the creativity and technical expertise applied to understanding the stated objectives of the managers of the packaging and marking programs by exploring opportunities that can be identified as a result of the collective experience and knowledge of those participating in the design and production of a package so as to streamline the development of the packaging, and identify any obstacles to production that may arise in the design process so as to reduce time and bring the prototype to completion and manufacturing. P3 or Production Planned Prototype emulates or simulates the specific print process chosen by insuring that the print process is replicable in final production. Plan involves the written, digital and graphic documentation relating to the prototype in a means by which the procedure used to create the prototype can be easily and predictably replicated in manufacturing. Plan includes a P3 print sample, black and white progressive proofs of the design, production specifications, key information learned or “learnings,” which provides an understanding as to where the design process was streamlined as well as, any obstacles or problems that were overcome during the creating of the prototype, together with digital support files used to guide the development of the mechanicals and color separation. The system and method achieved by implementing the above mentioned steps is able to reduce subjectivity in interpreting and creating a packaging prototype that realizes different ways to achieve the designer's vision and final design. In addition, the system and method achieved by implementing the above-mentioned parts is further able to allow for the management of the expectations of senior management responsible for the final product and its packaging while informing the printer of the best method by which the prototype can be printed.

The foregoing and other features and advantages of the present invention will be apparent from the following detailed description of the invention.

### BRIEF DESCRIPTION OF THE DRAWINGS

These and other features and advantages of the invention will now be described with reference to the accompanying drawings of certain preferred embodiments, which are intended to illustrate and not limit the invention, and in which:

FIG. 1A is a prior art view of the commercialization process involved in designing product packaging.

FIG. 1B(1) and (2) is a prior art view of the phased design process, where the process is combined along line A-A.

FIG. 1C is a prior art view of the communications links between the design manager and the designer, the printer and the separator.

FIG. 2 shows the relationship between the design manager and the suppliers where the design manager and the suppliers share a communication platform with one another.

FIG. 3 shows in block diagram the three-phased system in accordance with the teachings of the instant invention.

### DESCRIPTION OF THE PREFERRED EMBODIMENTS

Referring to the drawings in detail, there are illustrated therein various exemplary embodiments of the system and method made in accordance with the teachings of the instant invention. These exemplary embodiments should not be construed as limiting.

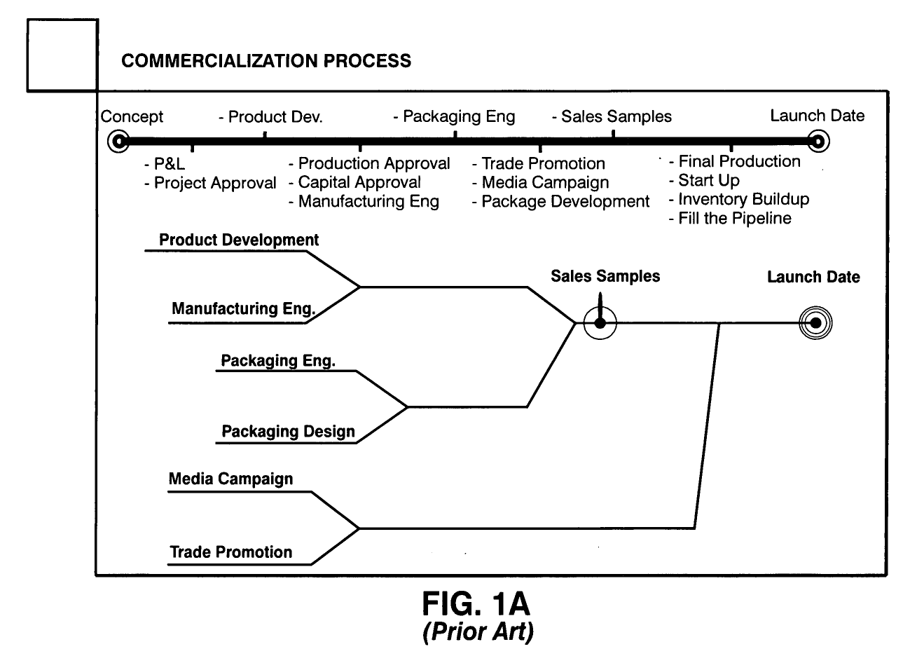

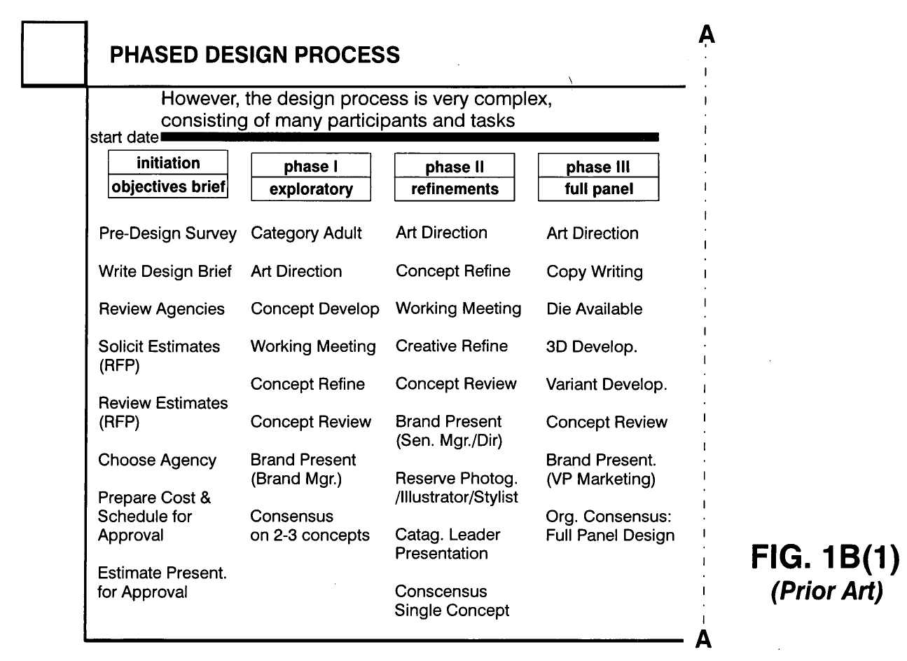

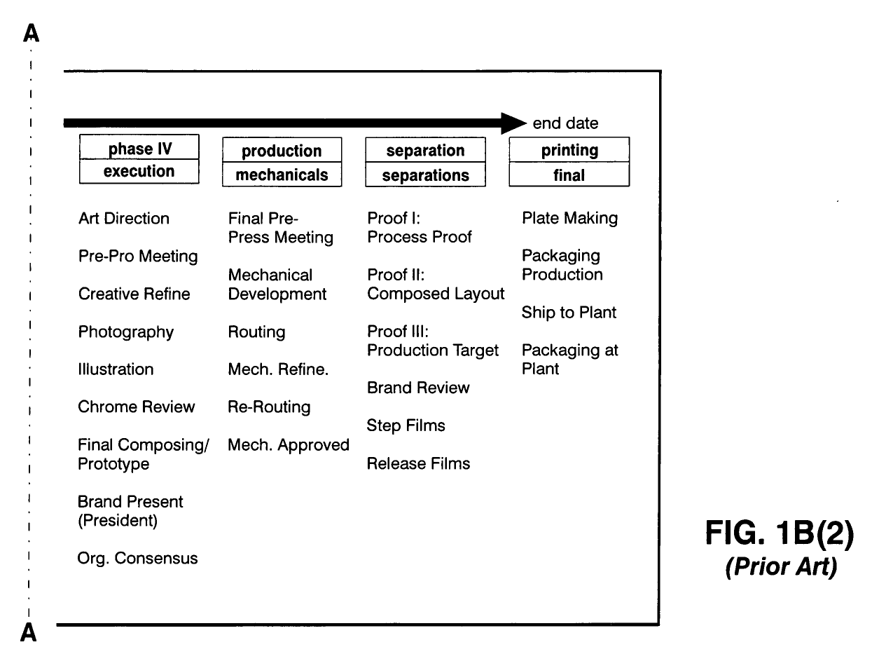

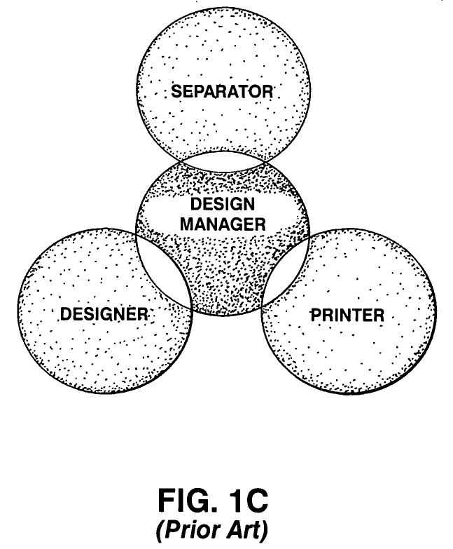

Referring to FIGS. 1A-1C, the prior art figures illustrate typical product development of a packaging design and a typical relationship between the design manager and the suppliers, as discussed above, which are responsible for bringing the product package to a launch date. As is evident in FIG. 1C, the design manager is in direct communication with the separator, the designer and the printer, yet the printer; the separator and the designer do not have a means by which to communicate with one another except through the design manager.

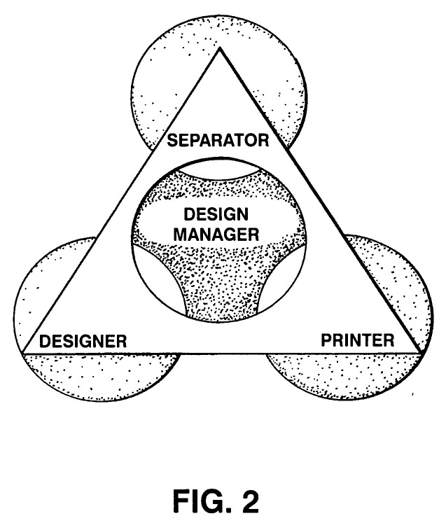

FIG. 2 shows the relationship between the designer manager and the suppliers where a communications platform has been established with one another. The process by which the communications platform is established is defined by a three-phase system, which includes Protocol, P3 or Production Planned Prototype and Plan. The above-mentioned three-phase system provides for direct communications between the suppliers and the design manager in the design of the prototype. The benefits of which are that the suppliers communicate with one another early in the design process whereby eliminating wasted time and redundancy since the suppliers are not working independently, but dependently, with one another. Another benefit is that the creative resources of the suppliers are leveraged towards greater innovation since each supplier influences the other suppliers so as to provide for rapid incremental improvements during the design process. A further benefit provided is that the communications platform keeps every supplier informed of developments and identifies challenges or problems faced in the design process to prevent them from actually becoming obstacles, which can potentially delay or push back the launch date of the packaging. Lastly, a key benefit provided is that each supplier shares files and information as changes are required, ensuring that the suppliers move in lock-step toward the predetermined launch date. The value of such file sharing is that it enables the communications platform which permits the suppliers to establish an advance development process, which saves time and effort later in the production process, while enabling creative problem solving so as to prevent conflicting supplier schedules.

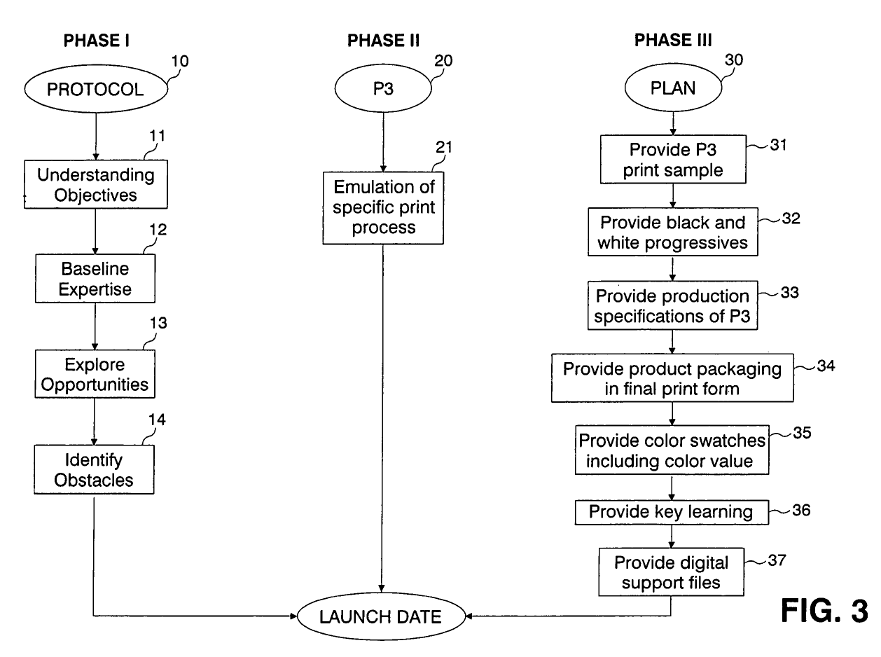

In the first phase as shown in FIG. 3, Protocol (10), provides for an application of collective skill, creativity and technical expertise in understanding the objectives (11), involved in designing the packaging by providing a target that informs and guides the production while establishing realistic expectations for senior management of the product to be developed. Baseline expertise (12) provides for implementing, based on design experience, the collective wisdom, knowledge and technical expertise of those involved in the product packaging. Protocol further provides for exploring opportunities (13) and identifying obstacles or problems (14), which may arise during the design process. The exploration of opportunities to create efficiencies and the identification of obstacles or problems are dependent on the collective wisdom, knowledge, creativity and technical expertise of those involved in providing for the execution and understanding of the objectives of the package designer and the design manager.

In the second phase, as shown in FIG. 3, a P3 or Production Planned Prototype (20) emulates the specific print process (21) chosen for final production. The print process chosen for final production of the packaging must be specifically chosen so as to replicate, as closely as possible, the look of the prototype, since all print processes do not yield the same results. The choice of an incorrect print process will result in a final package that fails to match the expected appearance established by the approved prototype. The final printing of the production packaging must be reflective of the prototype. The prototype, as stated above is inherently the first of its kind, and many processes and labor hours have been expended in the creation of the prototype. Such attention and work hours cannot be put into the mass printing of the packaging since the resulting packaging would not be cost effective. Therefore, a print process must be chosen that will emulate the prototype as closely as possible without destroying the creative aspects of the design by failing to effectively use the current technology available in today's printing methods.

In the third phase, as shown in FIG. 3, Plan (30) encompasses the written, digital and graphic documentation that guides a user who is reproducing the packaging. Technical and graphic information used in the design of the prototype and the subsequent packaging is presented in the Plan. The components of the Plan contain a P3 print sample (31) which shows the packaging in its final form together with black and white progressive proofs (32), which provide a black and white showing of the graphic elements that will eventually printed in the respective color, without the distraction of actual color, so that a user can perceive the characteristics and placement of the color used on the final packaging. The P3 print sample is a direct image proof which is defined in the production specifications (33), including the relevant color swatches (35) and the associated color values that are used in the prototype along with the type fonts, line count of the characters and the type of substrate the graphics are to be printed upon. The production specifications (33) includes a summary of the suppliers and the services each provided, together with the nature and size of materials and the colors employed, and the nature of the printing production method. The P3 may additionally include laminated transparencies, which show and define the amount and layering of the graphics so as to demonstrate how the print process will achieve the final package. Together with the P3, a color proof of the packaging in its final printed form (34) is included which demonstrates the proximity of the final printing to the P3. Also included in the sample are the available color swatches (35) which are used in the production of the P3 as well as the type fonts, the line count of the type characters, and the nature of the substrate to be printed upon. Both samples are provided so as to provide a comparison between the actual manufactured packaging to that of the P3 so as to confirm the benefits provided by using the communication platform early in the design and production process. The Plan further includes the Key Learnings (36), which outline the capabilities of the printing methods used as well as, the project objectives identified in the creation of P3. The capabilities and the project objectives and P3 are identified therein, each of which result from the communications platform between the separator, designer and printer. The capabilities encompass possible changes in client preferences with respect to the relation of the color intensity used in the P3 to changes in ink density based on the substrate, and its inherent physical characteristics of the type of printing. The project objectives set forth the manner in which communications between the client and design manager and suppliers changed throughout the process of creating the P3. This may include modifying the design parameters of the graphics to adjusting the print mechanicals to ensure that the actual manufacturing printing process coincides with the final production specifications. Lastly, digital support files (37) are included in the Plan which serves to guide the mechanical development and color separation of the graphics while providing a digital rendering of the P3.

1. A system and method of managing the development of a packaging prototype, comprising:
providing a packaging prototype system whereby said system dictates how the packaging for a product will be produced based on a production process between a design manager and suppliers, whereby a communications platform is established between the design manager and the suppliers.

2. The method as defined in claim 1, wherein the communications platform being established between the design manager and said suppliers, the suppliers consisting of a separator, a designer and a printer.

3. The method as defined in claim 1 wherein providing the packaging prototype system, said communications platform comprises a protocol, a production planned prototype, and a plan.

4. The method as defined in claim 3 wherein providing the packaging prototype system protocol involves understanding objectives, providing a baseline expertise, exploring production opportunities and identifying obstacles in the production process.

5. The method as defined in claim 3 wherein providing the packaging prototype system and the production planned prototype involves emulating a specific print process chosen for final production whereby the final production print process is replicable.

6. The method as defined in claim 3 wherein providing the packaging prototype system plan contains a print sample, black and white progressives, production specifications, product package in final print form, key information learned during the creation of the prototype, color swatches and digital support files whereby the plan provides documentation to replicate the packaging prototype and said package in final print form.
